(19) United States
(12) Patent Application Publication
(10) Pub. No.: US 2025/0371645 A1
(43) Pub. Date: Dec. 4, 2025

(54) JOINT TRAINING METHOD AND APPARATUS FOR WATERMARK EMBEDDING AND DETECTION, STORAGE MEDIUM, AND DEVICE

(71) Applicant: Alipay (Hangzhou) Information Technology Co., Ltd., Hangzhou (CN)

(72) Inventors: Jun LAN, Hangzhou (CN); Huijia ZHU, Hangzhou (CN); Weiqiang WANG, Hangzhou (CN)

(21) Appl. No.: 19/209,654

(22) Filed: May 15, 2025

(30) Foreign Application Priority Data
May 30, 2024 (CN) 202410693982.0

(51) Int. Cl. G06T 1/00; G06T 5/60; G06T 5/70

(52) U.S. Cl. CPC G06T 1/005; G06T 1/0028; G06T 5/60; G06T 5/70; G06T 2201/0064; G06T 2201/0065; G06T 2207/20081

(57) ABSTRACT

Implementations of the present specification provide a joint training method and apparatus for watermark embedding and detection, a storage medium, and a device. The method includes: obtaining training samples, the training samples each including an image watermark and a sample original image; performing encoding processing on the image watermark based on an image encoder to obtain an embedded-watermark representation corresponding to the image watermark; then inputting the embedded-watermark representation and the sample original image into a watermark encoder, so that the watermark encoder fuses the embedded-watermark representation into the sample original image to obtain a watermark-embedded image embedded with the image watermark; next, inputting the watermark-embedded image into a watermark decoder to obtain a detected watermark corresponding to the watermark-embedded image; and adjusting parameters of the image encoder, the watermark encoder, and the watermark decoder with optimization objectives of minimizing a difference between the detected watermark and the image watermark and minimizing a difference between the watermark-embedded image and the sample original image.

### TECHNICAL FIELD

The present specification relates to computer technologies, and in particular, to a joint training method and apparatus for watermark embedding and detection, a storage medium, and a device.

### BACKGROUND

Popularization of the Internet and rapid development of artificial intelligence technologies accelerate the dissemination and communication of digital media information such as images and videos. People can conveniently download desired digital media information over networks or generate digital media information by using artificial intelligence technologies. Digital media are characterized by ease of editing, modification, copying, and dissemination. While advancing the information society, these characteristics also lead to growing concerns regarding issues such as copyright protection, authenticity verification, and integrity authentication of digital media.

Adding watermarks to digital media for copyright protection, information tracing, and information verification is the key to addressing the issues of digital media copyright protection, privacy data preservation against infringement, and digital media information security.

### SUMMARY

Implementations of the present specification provide a joint training method and apparatus for watermark embedding and detection, a storage medium, and a device. By performing joint training on a watermark encoder for watermark embedding and a watermark decoder for watermark detection, a watermark encoder that imperceptibly adds an image watermark to an image and that improves a watermark embedding effect as well as a watermark decoder with a relatively good watermark detection effect can be obtained by training.

Other characteristics and technical features of the present specification will be clear from the following detailed descriptions or obtained in part through practice of the present specification.

According to a first aspect of implementations of the present specification, a joint training method for watermark embedding and detection is provided, which is applied to a watermark embedding and detection system. The watermark embedding and detection system includes an image encoder, a diffusion model-based watermark encoder, and a diffusion model-based watermark decoder. The method includes: obtaining training samples, the training samples each including an image watermark and a sample original image; performing encoding processing on the image watermark based on the image encoder to obtain an embedded-watermark representation corresponding to the image watermark; inputting the embedded-watermark representation and the sample original image into the watermark encoder, so that the watermark encoder fuses the embedded-watermark representation into the sample original image to obtain a watermark-embedded image embedded with the image watermark; inputting the watermark-embedded image into the watermark decoder to obtain a detected watermark corresponding to the watermark-embedded image; and adjusting parameters of the image encoder, the watermark encoder, and the watermark decoder with optimization objectives of minimizing a difference between the detected watermark and the image watermark and minimizing a difference between the watermark-embedded image and the sample original image.

In some example implementations of the present specification, based on the above solution, the training samples each further include a watermark-free representation corresponding to the image watermark, and the method further includes: before the inputting the watermark-embedded image into the watermark decoder to obtain the detected watermark corresponding to the watermark-embedded image, inputting the sample original image into the watermark decoder to obtain an original detected representation corresponding to the sample original image; the adjusting the parameters of the image encoder, the watermark encoder, and the watermark decoder with the optimization objectives of minimizing the difference between the detected watermark and the image watermark and minimizing the difference between the watermark-embedded image and the sample original image includes: adjusting the parameters of the image encoder, the watermark encoder, and the watermark decoder with optimization objectives of minimizing the difference between the detected watermark and the image watermark, minimizing the difference between the watermark-embedded image and the sample original image, and minimizing a difference between the original detected representation and the watermark-free representation.

In some example implementations of the present specification, based on the above solution, the inputting the embedded-watermark representation and the sample original image into the watermark encoder, so that the watermark encoder fuses the embedded-watermark representation into the sample original image to obtain the watermark-embedded image embedded with the image watermark includes: performing multi-step noise addition processing on the sample original image based on the watermark encoder to obtain a noise image; and performing diffusion denoising processing on the noise image based on the embedded-watermark representation to obtain the watermark-embedded image embedded with the image watermark.

In some example implementations of the present specification, based on the above solution, the performing the diffusion denoising processing on the noise image based on the embedded-watermark representation to obtain the watermark-embedded image embedded with the image watermark includes: performing denoising noise prediction based on the number of denoising times, the embedded-watermark representation, and the noise image to obtain denoising noise; performing denoising processing on the noise image based on the denoising noise to obtain an intermediate noise image; in response to the number of denoising times not being zero, subtracting one from the number of denoising times to obtain an updated number of denoising times, using the intermediate noise image as a new noise image, and carrying out the step of performing the denoising noise prediction based on the number of denoising times, the embedded-watermark representation, and the noise image to obtain the denoising noise; and in response to the number of denoising times being reduced to zero, using an intermediate noise image obtained from the latest denoising as the watermark-embedded image.

In some example implementations of the present specification, based on the above solution, the method further includes: before the inputting the watermark-embedded image into the watermark decoder to obtain the detected watermark corresponding to the watermark-embedded image, performing image enhancement processing on the watermark-embedded image to obtain an enhanced watermark image, where the inputting the watermark-embedded image into the watermark decoder to obtain the detected watermark corresponding to the watermark-embedded image includes: inputting the enhanced watermark image into the watermark decoder to obtain a detected watermark corresponding to the enhanced watermark image.

In some example implementations of the present specification, based on the above solution, the image enhancement processing includes at least one of image cropping processing, image brightness adjustment processing, image contrast adjustment processing, image grayscale processing, or image binarization processing.

According to a second aspect of implementations of the present specification, a watermark embedding method is provided, including: obtaining an original image and an image watermark corresponding to the original image; performing encoding processing on the image watermark based on the above image encoder to obtain an embedded-watermark representation corresponding to the image watermark; and performing encoding-based fusion on the original image and the image watermark representation based on the above watermark encoder to obtain a watermark-embedded image.

According to a third aspect of implementations of the present specification, a watermark detection method is provided, including: inputting a watermark embedded image under detection into the above watermark decoder, and performing decoding processing based on the watermark decoder to obtain a detected watermark corresponding to the watermark-embedded image.

According to a fourth aspect of implementations of the present specification, a joint training apparatus for watermark embedding and detection is provided, including: a sample acquisition module, configured to obtain training samples, the training samples each including an image watermark and a sample original image; a representation extraction module, configured to perform encoding processing on the image watermark based on the image encoder to obtain an embedded-watermark representation corresponding to the image watermark; a watermark embedding module, configured to input the embedded-watermark representation and the sample original image into the watermark encoder, so that the watermark encoder fuses the embedded-watermark representation into the sample original image to obtain a watermark-embedded image embedded with the image watermark; a watermark detection module, configured to input the watermark-embedded image into the watermark decoder to obtain a detected watermark corresponding to the watermark-embedded image; and a parameter tuning module, configured to adjust parameters of the image encoder, the watermark encoder, and the watermark decoder with optimization objectives of minimizing a difference between the detected watermark and the image watermark and minimizing a difference between the watermark-embedded image and the sample original image.

According to a fifth aspect of implementations of the present specification, a storage medium is provided, which has a computer program stored thereon. When executed by a processor, the computer program implements steps of the method according to any one of the above implementations.

According to a sixth aspect of the implementations of the present specification, an electronic device is provided, including a processor and a memory. The memory stores a computer-readable instruction that is applicable to being loaded by the processor and implementing steps of the method according to any one of the above implementations.

According to a seventh aspect of the implementations of the present specification, a computer program product is provided, which has at least one instruction stored thereon. When executed by a processor, the at least one instruction implements steps of the method according to any one of the above implementations.

The technical solutions provided in the implementations of the present specification can include the following beneficial effects:

According to the joint training techniques for watermark embedding and detection in the example implementations of the present specification, training samples each including an image watermark and a sample original image are obtained; then a watermark encoder and a watermark decoder in a watermark embedding and detection system are trained based on the training samples; in a training process, an embedded-watermark representation corresponding to the image watermark is first extracted based on an image encoder, and then the embedded-watermark representation and a noise image are input into the watermark encoder, so that the watermark encoder fuses the embedded-watermark representation into the sample original image to obtain a watermark-embedded image embedded with the image watermark; next, the watermark-embedded image is input into the watermark decoder to obtain a detected watermark corresponding to the watermark-embedded image; and in the training process, parameters of the image encoder, the watermark encoder, and the watermark decoder are adjusted with optimization objectives of minimizing a difference between the detected watermark and the image watermark and minimizing a difference between the watermark-embedded image and the sample original image. After training, a watermark encoder for watermark embedding and a watermark decoder for watermark detection can be obtained. With the joint training, accuracy of watermark embedding and watermark detection can be ensured. By way of multi-step noise addition and multi-step denoising, a diffusion model-based auto-encoder can embed the image watermark into the sample original image. Such implementation can improve imaging quality of the watermark-embedded image obtained after watermark embedding, thereby reducing a difference between the watermark-embedded image and the sample original image, and improving a watermark embedding effect.

### BRIEF DESCRIPTION OF DRAWINGS

The accompanying drawings herein are incorporated into the present specification and constitute a part of the present specification. These accompanying drawings show implementations consistent with the present specification, and are used with the present specification to explain a principle of the present specification. Clearly, the accompanying drawings in the following description show merely some implementations of the present specification, and a person of ordinary skill in the art can further derive other accompany drawings based on these accompanying drawings without innovative efforts.

FIG. 1 is a schematic diagram illustrating an application scenario of a joint training method for watermark embedding and detection according to an implementation of the present specification;

FIG. 2 is a schematic flowchart illustrating a joint training method for watermark embedding and detection according to an implementation of the present specification;

FIG. 3 is a schematic diagram illustrating joint training according to an implementation of the present specification;

FIG. 4 is a schematic flowchart illustrating a joint training method for watermark embedding and detection according to an implementation of the present specification;

FIG. 5 is a schematic diagram illustrating joint training according to an implementation of the present specification;

FIG. 6 is a schematic structural diagram illustrating a joint training apparatus for watermark embedding and detection according to an implementation of the present specification;

FIG. 7 is a schematic structural diagram illustrating a joint training apparatus for watermark embedding and detection according to an implementation of the present specification; and

FIG. 8 is a schematic structural diagram illustrating an electronic device according to an implementation of the present specification.

### DESCRIPTION OF IMPLEMENTATIONS

To make the objectives, technical solutions, and advantages of the present specification clearer, the following clearly and comprehensively describes the technical solutions in the present specification with reference to specific implementations of the present specification and corresponding accompanying drawings. Clearly, the described implementations are merely some rather than all of the implementations of the present specification. All other implementations obtained by a person of ordinary skill in the art based on the implementations of the present specification without innovative efforts all fall within the protection scope of the present specification.

A digital watermark technology refers to embedding digital information (i.e., a digital watermark) into an image in a hidden manner without affecting visual quality and integrity of the image, and is applicable to scenarios such as copyright protection, leakage tracing, file verification, and the like. In related technologies, watermark embedding is performed by simply fusing a watermark with an image, and a watermark embedding trace is obvious, a difference between images before and after the watermark embedding is significant, and a watermark embedding process is relatively simplistic, causing undesirable watermark embedding and detection effects and relatively poor security and stability.

On this basis, the present specification proposes a joint training method for watermark embedding and detection. With this method, by performing joint training on a watermark encoder for watermark embedding and a watermark decoder for watermark detection, a watermark encoder that imperceptibly adds a digital watermark to an image and that improves a watermark embedding effect as well as a watermark decoder with a relatively good watermark detection effect can be obtained by training.

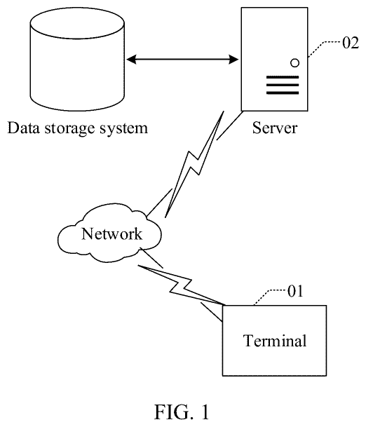

The joint training techniques for watermark embedding and detection provided in implementations of the present specification can be applied to an application environment shown in FIG. 1. A terminal 01 communicates with a server 02 over a network. A data storage system can store data that needs to be processed by the server 02. The data storage system can be integrated on the server 02, or can be deployed on a cloud or another server. When a user of the terminal 01 needs to perform joint training for watermark embedding and detection, training samples can be provided to the server 02. The server 02 obtains the training samples, and performs, based on the training samples, the joint training method for watermark embedding and detection. The terminal 01 can be but is not limited to various desktop computers, notebook computers, smartphones, tablets, Internet of Things devices, and portable wearable devices. The Internet of Things devices can be smart speakers, smart televisions, smart air conditioners, smart in-vehicle devices, or the like. The portable wearable devices can be smart watches, smart bands, head-mount devices, or the like. The server 02 can be implemented by a standalone server, a server cluster including multiple servers, or a cloud server.

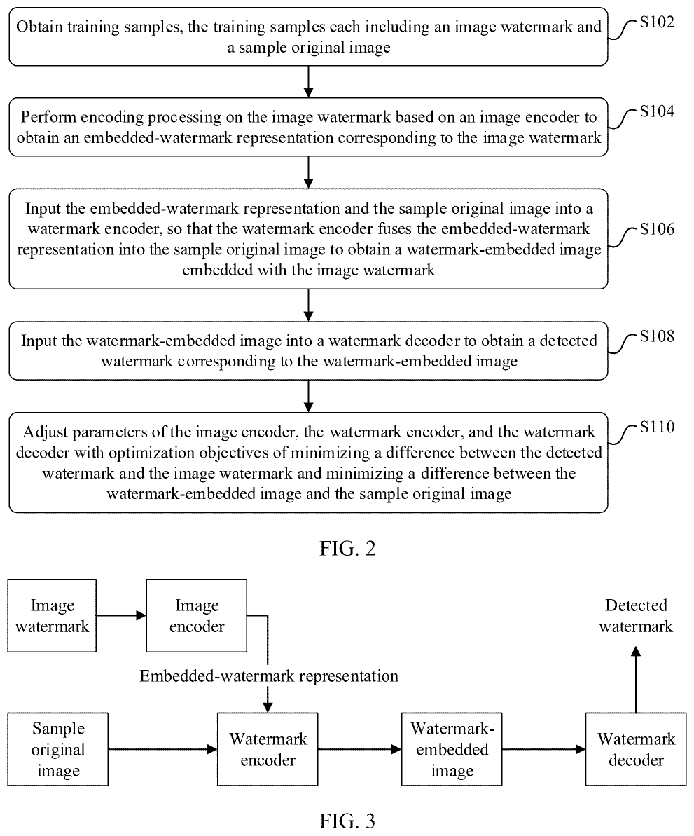

FIG. 2 is a schematic flowchart illustrating a joint training method for watermark embedding and detection according to an implementation of the present specification. In implementations of the present specification, the joint training method for watermark embedding and detection is applied to a joint training apparatus for watermark embedding and detection or an electronic device configured with the joint training apparatus for watermark embedding and detection. In implementations, the electronic device configured with the joint training apparatus for watermark embedding and detection can be a server. The following describes in detail a process shown in FIG. 2 by using a server as an execution body. The joint training method for watermark embedding and detection can, in some implementations, include the following steps:

S102: Obtain training samples, the training samples each including an image watermark and a sample original image.

The image watermark is an image imprint to be added to the sample original image. The image watermark can include an identifier such as a text or a pattern.

It can be understood that before training is performed, a training data set used for the training is pre-constructed, and the training data set includes multiple training samples. The training samples each include an image watermark and a sample original image.

It should be noted that the joint training method for watermark embedding and detection proposed in one or more implementations of the present specification is applied to a watermark embedding and detection system. The watermark embedding and detection system includes a watermark encoder and a watermark decoder. The watermark encoder is configured to embed a watermark into an image. The watermark decoder is configured to perform watermark detection on a watermark-embedded image embedded with a watermark.

Further, the watermark encoder proposed in the one or more implementations of the present specification is a diffusion model-based encoder, and the diffusion model has relatively good stability and attack resistance. When watermark embedding is performed, a high-quality image can be generated, and a watermark embedding effect can be improved. The watermark decoder can be implemented based on a convolutional neural network (CNN), but is not limited to a specific CNN structure (e.g., ResNet, MobileNet, etc.), or can even be an RNN or transformer structure.

S104: Perform encoding processing on the image watermark based on the image encoder to obtain an embedded-watermark representation corresponding to the image watermark.

In one or more implementations of the present specification, after the training samples are obtained, the image watermark is first encoded by using the image encoder to extract the embedded-watermark representation corresponding to the image watermark.

In some implementations, the image encoder can be a ControlNet neural network model. In a watermark embedding process, ControlNet can provide an additional control condition for the diffusion model-based watermark encoder to guide generation of the watermark-embedded image, thereby improving a generation effect of the watermark-embedded image.

S106: Input the embedded-watermark representation and the sample original image into the watermark encoder, so that the watermark encoder fuses the embedded-watermark representation into the sample original image to obtain a watermark-embedded image embedded with the image watermark.

In one or more implementations of the present specification, after the embedded-watermark representation corresponding to the image watermark is obtained, the embedded-watermark representation and a noise graph or image are input into the diffusion model-based watermark encoder. The watermark encoder fuses the embedded-watermark representation into the sample original image to obtain the watermark-embedded image embedded with the image watermark.

In an implementation, after the embedded-watermark representation and the sample original image are input into the watermark encoder, the watermark encoder first adds noise to the sample original image based on an image diffusion algorithm to obtain a noise image, then guides a denoising process by using the embedded-watermark representation as a condition, and performs diffusion denoising processing on the noise image based on the image diffusion algorithm to obtain the watermark-embedded image.

In some implementations, the number of noise addition steps can be predetermined. When noise addition processing is performed on the sample original image, multi-step noise addition processing is performed on the sample original image based on the predetermined number of noise addition steps, to obtain the noise image.

In some implementations, the number of denoising times is predetermined. In a process of performing denoising processing on the noise image based on the embedded-watermark representation, multi-step denoising is performed on the noise image based on the predetermined number of denoising times, to finally obtain the watermark-embedded image.

It should be noted that the watermark encoder is configured to guide denoising processing on the noise image by using the embedded-watermark representation as a condition, and fuse the embedded-watermark representation into the noise image in the multi-step denoising process. In some implementations, in the process of performing denoising processing on the noise image, the denoising process is guided by using the embedded-watermark representation as a condition, so that the embedded-watermark representation is fused into the noise image in the denoising process to obtain the watermark-embedded image embedded with the image watermark.

In some implementations, performing the diffusion denoising processing on the noise image based on the embedded-watermark representation to obtain the watermark-embedded image embedded with the image watermark can be: performing denoising noise prediction based on the number of denoising times, the embedded-watermark representation, and the noise image to obtain denoising noise; performing denoising processing on the noise image based on the denoising noise to obtain an intermediate noise image; in response to the number of denoising times not being zero, subtracting one from the number of denoising times to obtain an updated number of denoising times, using the intermediate noise image as a new noise image, and carrying out the step of performing the denoising noise prediction based on the number of denoising times, the embedded-watermark representation, and the noise image to obtain the denoising noise; and in response to the number of denoising times being reduced to zero, using an intermediate noise image obtained from the latest denoising as the watermark-embedded image.

The number of denoising times can be a predefined or dynamically determined number of times and the watermark encoder is enabled to perform denoising processing on the noise image based on the number of denoising times to obtain the watermark-embedded image. The number of denoising times can correspond to the number of noise addition times. In some implementations, the watermark encoder includes a noise prediction unit. In each denoising process, the noise prediction unit is configured to perform noise prediction based on the number of denoising times, the noise image, and the embedded-watermark representation corresponding to the image watermark to obtain predicted noise. The predicted noise is subtracted from the noise image to obtain an intermediate noise image obtained after the current round of denoising. After denoising processing is performed for the predefined number of times, the watermark-embedded image is obtained.

S108: Input the watermark-embedded image into the watermark decoder to obtain a detected watermark corresponding to the watermark-embedded image.

After the watermark-embedded image is obtained, the watermark-embedded image is input into the watermark decoder, so that the watermark decoder performs decoding processing on the watermark-embedded image, to detect and extract the image watermark embedded into the watermark-embedded image and obtain the detected watermark.

S110: Adjust parameters of the image encoder, the watermark encoder, and the watermark decoder with optimization objectives of minimizing a difference between the detected watermark and the image watermark and minimizing a difference between the watermark-embedded image and the sample original image.

For example, a difference loss between the detected watermark and the image watermark and a difference loss between the watermark-embedded image and the sample original image are calculated based on a pre-constructed loss function, and the network parameters of the image encoder, the watermark encoder, and the watermark decoder are adjusted and optimized based on the two difference losses.

It can be understood that the watermark-embedded image is an image obtained after the sample original image is embedded with the image watermark. By calculating the difference loss between the watermark-embedded image and the sample original image, the parameters of the watermark encoder and the watermark decoder are adjusted with minimizing the difference between the watermark-embedded image and the sample original image as one of the optimization objectives. As such, the difference between the watermark-embedded image output by the watermark encoder and the sample original image can be constantly decreased, and a watermark embedding effect can be improved. The image watermark is a watermark actually embedded into the sample original image, and the detected watermark is a watermark extracted by the watermark decoder from the watermark-embedded image. The detected watermark obtained by the watermark decoder by decoding tends to be consistent with the image watermark, thereby ensuring a watermark embedding effect of the watermark encoder and a watermark detection effect of the watermark decoder.

FIG. 3 is a schematic diagram illustrating joint training according to an implementation of the present specification. After the image watermark and the sample original image are obtained, the image encoder is used to firstly extract the embedded-watermark representation corresponding to the image watermark, and then input the embedded-watermark representation and the sample original image into the diffusion model-based watermark encoder to obtain the watermark-embedded image fused with the embedded-watermark representation. Then, the watermark-embedded image is input into the watermark decoder to obtain the detected watermark output by the watermark decoder by decoding, so as to adjust the parameters of the watermark encoder and the watermark decoder with the optimization objectives of minimizing the difference between the detected watermark and the image watermark and minimizing the difference between the watermark-embedded image and the sample original image.

In implementations, training samples each including an image watermark and a sample original image are obtained; then a watermark encoder and a watermark decoder in a watermark embedding and detection system are trained based on the training samples; in a training process, an embedded-watermark representation corresponding to the image watermark is first extracted based on an image encoder, and then the embedded-watermark representation and a noise image are input into the watermark encoder, so that the watermark encoder fuses the embedded-watermark representation into the sample original image to obtain a watermark-embedded image embedded with the image watermark; next, the watermark-embedded image is input into the watermark decoder to obtain a detected watermark corresponding to the watermark-embedded image; and in the training process, parameters of the image encoder, the watermark encoder, and the watermark decoder are adjusted with optimization objectives of minimizing a difference between the detected watermark and the image watermark and minimizing a difference between the watermark-embedded image and the sample original image. After training, a watermark encoder for watermark embedding and a watermark decoder for watermark detection can be obtained. With joint training, accuracy of watermark embedding and watermark detection can be ensured. By way of noise addition and denoising, a diffusion model-based auto-encoder can embed the image watermark into the sample original image. Such implementation can improve imaging quality of the watermark-embedded image obtained after watermark embedding, thereby reducing the difference between the watermark-embedded image and the sample original image, and improving a watermark embedding effect.

FIG. 4 is a schematic flowchart illustrating a joint training method for watermark embedding and detection according to an implementation of the present specification. The method includes the following steps:

S202: Obtain training samples, the training samples each including an image watermark and a sample original image.

For step S202, reference can be made to detailed descriptions of step S102 in another implementation of the present specification. Details are omitted herein for simplicity.

S204: Perform encoding processing on the image watermark based on an image encoder to obtain an embedded-watermark representation corresponding to the image watermark.

For step S204, reference can be made to detailed descriptions of step S104 in another implementation of the present specification. Details are omitted herein for simplicity.

S206: Input the embedded-watermark representation and the sample original image into a watermark encoder, so that the watermark encoder fuses the embedded-watermark representation into the sample original image to obtain a watermark-embedded image embedded with the image watermark.

For step S206, reference can be made to detailed descriptions of step S106 in another implementation of the present specification. Details are omitted herein for simplicity.

S208: Perform image enhancement processing on the watermark-embedded image to obtain an enhanced watermark image.

In implementations of the present specification, after the watermark-embedded image output by the watermark encoder is obtained, the image enhancement processing is performed on the watermark-embedded image to obtain the enhanced watermark image. The image enhancement processing includes at least one of image cropping processing, image brightness adjustment processing, image contrast adjustment processing, image grayscale processing, or image binarization processing.

It should be noted that perturbation is added to the watermark-embedded image to obtain the enhanced watermark image. In this way, training effects and robustness of the watermark encoder and the watermark decoder can be improved.

S210: Input the enhanced watermark image into a watermark decoder to obtain a detected watermark corresponding to the enhanced watermark image.

The enhanced watermark image is an image obtained after image perturbation is added to the watermark-embedded image.

The detected watermark is a watermark extracted by the watermark decoder from the watermark-embedded image, and the detected watermark obtained by the watermark decoder by decoding should tend to be consistent with the originally embedded image watermark, thereby ensuring a watermark embedding effect of the watermark encoder and a watermark detection effect of the watermark decoder.

S212: Input the sample original image into the watermark decoder to obtain an original detected representation corresponding to the sample original image.

In a feasible implementation, while the enhanced watermark image is decoded based on the watermark decoder, the sample original image is input to the watermark decoder for decoding, so that the watermark decoder extracts a detected watermark representation from the sample original image to obtain the original detected representation obtained by the watermark decoder by decoding the sample original image.

Because no image watermark is added to the sample original image, in implementations of the present specification, a watermark representation corresponding to the sample original image without the image watermark can be set as a predetermined representation, i.e., the original detected representation obtained by the watermark decoder by decoding the sample original image should conform to the predetermined representation, so that the watermark decoder can accurately identify an image without the watermark, thereby improving a watermark detection effect.

S214: Adjust parameters of the image encoder, the watermark encoder, and the watermark decoder with optimization objectives of minimizing a difference between the detected watermark and the image watermark and minimizing a difference between the watermark-embedded image and the sample original image.

It should be noted that the embedded-watermark representation is a numerical representation corresponding to the image watermark, and the detected watermark is a watermark representation obtained by the watermark decoder by decoding the watermark-embedded image after the image watermark is embedded into the sample original image. By identifying the difference between the image watermark and the detected watermark by comparison, parameter tuning training is performed on the watermark encoder and the watermark decoder with the optimization objective of minimizing the difference between the image watermark and the detected watermark. In this way, the watermark embedding effect of the watermark encoder and the watermark detection effect of the watermark decoder can both be improved. The watermark-embedded image is an image obtained after the sample original image is embedded with the image watermark. By identifying the difference between the watermark-embedded image and the sample original image by comparison, parameter tuning training is performed on the watermark encoder with the optimization objective of minimizing the difference between the watermark-embedded image and the sample original image. In this way, the watermark embedding effect of the watermark encoder can be improved, so that the difference between the watermark-embedded image obtained after watermark embedding and the original image can be minimized, thereby implementing imperceptible watermark embedding. The original detected representation is a watermark representation obtained by the watermark decoder by decoding the sample original image without the image watermark, and a watermark-free representation is a watermark representation predetermined for an image without a watermark embedded. The original detected representation obtained by the watermark decoder by decoding the sample original image should conform to the watermark-free representation. By identifying a difference between the original detected representation and the watermark-free representation by comparison, parameter tuning training is performed on the watermark decoder with the optimization objective of minimizing the difference between the original detected representation and the watermark-free representation. In this way, the watermark decoder can accurately identify an image without the watermark, thereby improving the watermark detection effect.

In a feasible implementation, a first loss between the image watermark and the detected watermark is calculated based on a predetermined first loss function; a second loss between the watermark-embedded image and the sample original image is calculated based on a predetermined second loss function; a third loss between the original detected representation and the watermark-free representation is calculated based on a predetermined third loss function; and the network parameters corresponding to the watermark encoder and the watermark decoder are adjusted based on the first loss, the second loss, and the third loss.

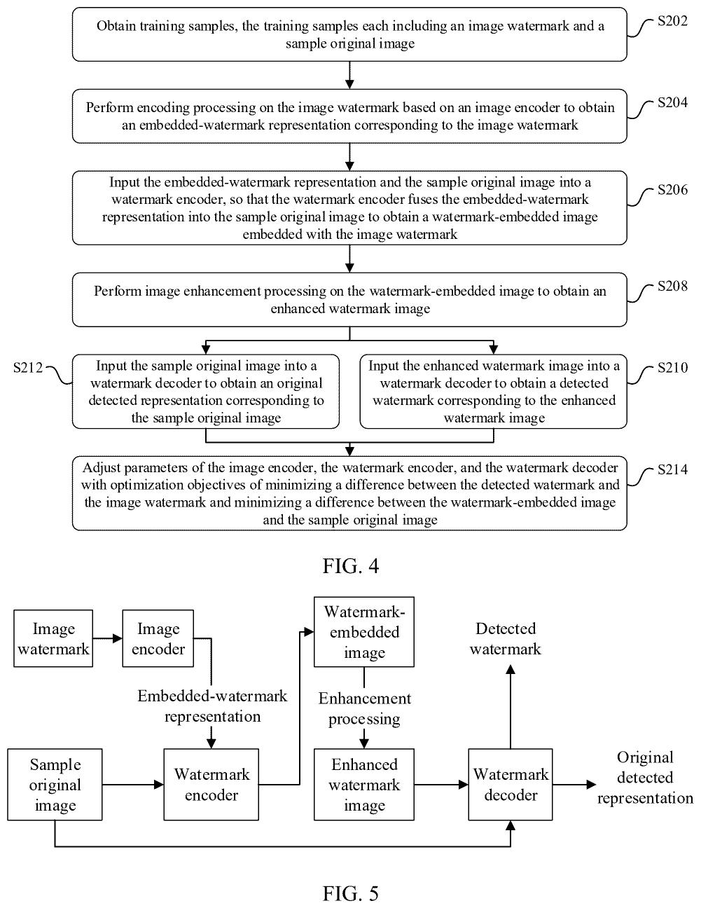

FIG. 5 is a schematic diagram illustrating joint training according to an implementation of the present specification. As shown in FIG. 5, after the image watermark and the sample original image are obtained, the image encoder is used to first extract the embedded-watermark representation corresponding to the image watermark, and then input the embedded-watermark representation and the sample original image into the diffusion model-based watermark encoder to obtain the watermark-embedded image fused with the embedded-watermark representation. Then, image enhancement processing is performed on the watermark-embedded image, and the enhanced watermark image obtained after the enhancement processing is input into the watermark decoder to obtain the detected watermark output by the watermark decoder by decoding while the sample original image is input into the watermark decoder at the same time for synchronous decoding, so as to obtain the original detected representation corresponding to the sample original image, and further to adjust the parameters of the image encoder, the watermark encoder, and the watermark decoder with the optimization objectives of minimizing the difference between the detected watermark and the image watermark, minimizing the difference between the watermark-embedded image and the sample original image, and minimizing the difference between the original detected representation and the watermark-free representation.

In implementations of the present specification, training samples each including an image watermark and a sample original image are obtained; then a watermark encoder and a watermark decoder in a watermark embedding and detection system are trained based on the training samples; in a training process, an embedded-watermark representation corresponding to the image watermark is first extracted based on an image encoder, and then the embedded-watermark representation and a noise image are input into the watermark encoder, so that the watermark encoder fuses the embedded-watermark representation into the sample original image to obtain a watermark-embedded image embedded with the image watermark; image enhancement processing is performed on the watermark-embedded image and then an enhanced watermark image obtained after the enhancement processing is input into the watermark decoder to obtain a detected watermark corresponding to the enhanced watermark image, while the sample original image is input into the water decoder at the same time to obtain an original detected representation corresponding to the sample original image; and in the training process, parameters of the image encoder, the watermark encoder, and the watermark decoder are adjusted with optimization objectives of minimizing a difference between the detected watermark and the image watermark, minimizing a difference between the watermark-embedded image and the sample original image, and minimizing a difference between the original detected representation and a watermark-free representation. After training, a watermark encoder for watermark embedding and a watermark decoder for watermark detection can be obtained. With joint training, accuracy of watermark embedding and watermark detection can be ensured. By way of multi-step noise addition and multi-step denoising, a diffusion model-based auto-encoder can embed the watermark into the sample original image. Such implementation can improve imaging quality of the watermark-embedded image obtained after watermark embedding, thereby reducing the difference between the watermark-embedded image and the sample original image, and improving a watermark embedding effect.

The present specification further proposes a watermark embedding method. The method includes: obtaining an original image and an image watermark corresponding to the original image; performing encoding processing on the image watermark based on an image encoder obtained by training by using the above method, to obtain an image watermark representation corresponding to the image watermark; and performing encoding-based fusion on the original image and the image watermark representation based on a watermark encoder obtained by training by using the method according to any one of the above implementations, to obtain a watermark-embedded image.

In some implementations, when a watermark needs to be added to an image, an original image to be embedded with a watermark and an image watermark to be embedded into the original image are obtained; an image watermark representation corresponding to the image watermark is extracted by using the image encoder; and the image watermark representation and the original image are input into the watermark encoder obtained by training by using the above method, so that the original image and the image watermark representation are fused by using the watermark encoder to finally obtain a watermark-embedded image fused with the image watermark representation.

Similar to a training process, when the watermark encoder performs fusion processing on the original image and the image watermark representation, the watermark encoder first adds noise to the original image based on an image diffusion algorithm to obtain a noise image, then guides a denoising process by using the image watermark representation as a condition, and performs diffusion denoising processing on the noise image based on the image diffusion algorithm to obtain the watermark-embedded image embedded with the image watermark. The diffusion denoising processing is performed on the noise image based on the image diffusion algorithm. Further, In some implementations, denoising noise prediction is performed based on the number of denoising times, the image watermark representation, and the noise image to obtain denoising noise; denoising processing is performed on the noise image based on the denoising noise to obtain an intermediate noise image; in response to the number of denoising times not being zero, one is subtracted from the number of denoising times to obtain an updated number of denoising times, the intermediate noise image is used as a new noise image, and the step of performing the denoising noise prediction based on the number of denoising times, the image watermark representation, and the noise image is carried out; and in response to the number of denoising times being reduced to zero, an intermediate noise image obtained from the latest denoising is used as the watermark-embedded image.

In an implementation, the watermark embedding method can be used to implement copyright protection for a copyrighted image. A copyright identifier corresponding to the copyrighted image is used as an image watermark. The copyright identifier corresponding to the copyrighted image can be embedded into the copyrighted image by using the watermark encoder. Upon an infringement issue, the copyright identifier in the image can be proved for rights protection, thereby protecting legitimate rights and interests of an image copyright holder.

Further, when the copyright identifier is a text identifier, an image watermark including the copyright identifier can be generated. The image watermark including the copyright identifier can be embedded by the watermark encoder into a copyrighted image requiring copyright protection. Upon an infringement issue, legitimate rights and interests of an image copyright holder are protected by extracting the image watermark from the copyrighted image, parsing the copyright identifier in the image watermark, and determining copyright ownership of the image based on the copyright identifier obtained through parsing.

In addition, the present specification further proposes a watermark detection method. The method includes: inputting a watermark embedded image under detection into the watermark decoder according to any one of the above implementations, and performing decoding processing based on the watermark decoder to obtain a detected watermark.

In some implementations, when watermark detection is needed, the watermark embedded image under detection is input into the watermark decoder, and watermark detection is performed by using the watermark decoder to obtain the detected watermark.

In an implementation, the watermark detection method can be applied to rights protection processing for a copyrighted image. The watermark decoder is used to extract a detected watermark corresponding to an infringing image from the infringing image, compares the detected watermark with a copyright identifier corresponding to a copyrighted image, and uses a comparison result as evidence for determining whether the infringing image constitutes an infringement, so as to protect legitimate rights and interests of an image copyright holder.

In an implementation, the watermark detection method can be applied to a verification phase for a copyrighted image. The watermark decoder is used to decode a watermark-embedded image under verification, extract a corresponding detected watermark from the watermark-embedded image, compare the detected watermark with a copyright identifier corresponding to a copyrighted image, and determine whether the watermark-embedded image is a copyrighted image.

Further, watermark character information is identified from the detected watermark by using an optical character recognition algorithm, the watermark character information is compared with the copyright identifier corresponding to the copyrighted image, and a comparison result is used as evidence for determining whether an infringing image constitutes an infringement, so as to protect legitimate rights and interests of an image copyright holder.

It can be understood that, when a copyright identifier corresponding to a copyrighted image is a character identifier, according to the watermark embedding method provided in implementations of the present specification, an image watermark including the character identifier can be embedded into an image that needs copyright marking, to obtain a watermark-embedded image. During watermark detection, the watermark decoder is used to obtain a detected watermark from a watermark-embedded image by decoding, then perform character recognition on the detected watermark to obtain a corresponding detected watermark character, and compare the detected watermark character with a copyright identifier to determine whether the watermark-embedded image is a copyrighted image including the copyright identifier.

It should be noted that, when a copyright identifier is a character identifier, the watermark embedding and detection system obtained by training in implementations of the present specification embeds an image watermark including the character identifier into an image to which the identifier needs to be added, or the watermark decoder is used to detect a watermark from an image. During representation verification, only character recognition needs to be performed on a detected watermark to obtain a detected watermark character, and the detected watermark character and a character identifier are compared for verification. When a certain difference exists between a detected watermark and an embedded image watermark, a verification result is not affected, and robustness is relatively good.

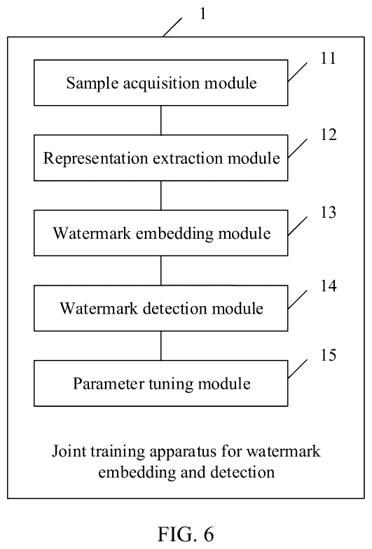

FIG. 6 is a schematic structural diagram illustrating a joint training apparatus for watermark embedding and detection according to an implementation of the present specification. As shown in FIG. 6, the joint training apparatus 1 for watermark embedding and detection can be implemented as a whole or a part of an electronic device by software, hardware, or a combination thereof. According to some implementations, the joint training apparatus 1 for watermark embedding and detection includes a sample acquisition module 11, a representation extraction module12, a watermark embedding module 13, a watermark detection module 14, and a parameter tuning module 15.

The sample acquisition module 11 is configured to obtain training samples, the training samples each including an image watermark and a sample original image.

The representation extraction module 12 is configured to perform encoding processing on the image watermark based on the image encoder to obtain an embedded-watermark representation corresponding to the image watermark.

The watermark embedding module 13 is configured to input the embedded-watermark representation and the sample original image into the watermark encoder, so that the watermark encoder fuses the embedded-watermark representation into the sample original image to obtain a watermark-embedded image embedded with the image watermark.

The watermark detection module 14 is configured to input the watermark-embedded image into the watermark decoder to obtain a detected watermark corresponding to the watermark-embedded image.

The parameter tuning module 15 is configured to adjust parameters of the image encoder, the watermark encoder, and the watermark decoder with optimization objectives of minimizing a difference between the detected watermark and the image watermark and minimizing a difference between the watermark-embedded image and the sample original image.

In some implementations, the watermark detection module 14 is further configured to input the sample original image into the watermark decoder to obtain an original detected representation corresponding to the sample original image; and

The parameter tuning module 15 is configured to adjust the parameters of the image encoder, the watermark encoder, and the watermark decoder with optimization objectives of minimizing the difference between the detected watermark and the image watermark, minimizing the difference between the watermark-embedded image and the sample original image, and minimizing a difference between the original detected representation and the watermark-free representation.

In some implementations, the watermark embedding module 13 is configured to perform multi-step noise addition processing on the sample original image based on the watermark encoder to obtain a noise image; and perform diffusion denoising processing on the noise image based on the embedded-watermark representation to obtain the watermark-embedded image embedded with the image watermark.

In some implementations, when performing the diffusion denoising processing on the noise image based on the embedded-watermark representation to obtain the watermark-embedded image embedded with the image watermark, the watermark embedding module 13 is configured to perform denoising noise prediction based on the number of denoising times, the embedded-watermark representation, and the noise image to obtain denoising noise; perform denoising processing on the noise image based on the denoising noise to obtain an intermediate noise image; in response to the number of denoising times not being zero, subtracting one from the number of denoising times to obtain an updated number of denoising times, use the intermediate noise image as a new noise image, and carry out the step of performing the denoising noise prediction based on the number of denoising times, the embedded-watermark representation, and the noise image to obtain the denoising noise; and in response to the number of denoising times being reduced to zero, use an intermediate noise image obtained from the latest denoising as the watermark-embedded image.

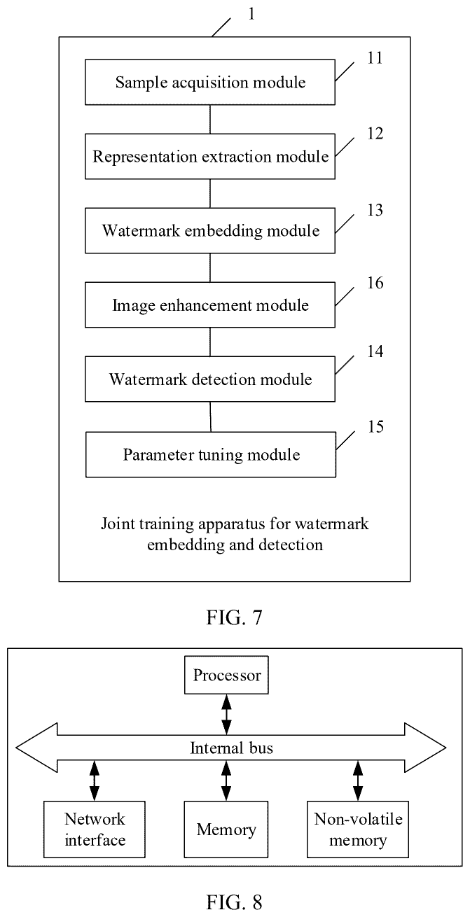

In some implementations, referring to FIG. 7, the apparatus further includes an image enhancement module 16, and the image enhancement module 16 is configured to perform image enhancement processing on the watermark-embedded image to obtain an enhanced watermark image, where the watermark detection module 14 is configured to input the enhanced watermark image into the watermark decoder to obtain a detected watermark corresponding to the enhanced watermark image.

In some implementations, the image enhancement processing includes at least one of image cropping processing, image brightness adjustment processing, image contrast adjustment processing, image grayscale processing, or image binarization processing.

The above apparatus implementation correspond to the method implementations. For specific descriptions, reference can be made to some of the descriptions of the method implementations. Details are omitted herein for simplicity. The apparatus implementations are obtained based on the corresponding method implementations, and have the same technical effects as the corresponding method implementations. For specific descriptions, reference can be made to the corresponding method implementations.

An implementation of the present specification further provides a computer storage medium. The computer storage medium can store a computer program. The computer program is applicable to being loaded by a processor and executing the method in implementations shown in FIG. 1 to FIG. 5. For a specific execution process, reference can be made to specific descriptions of the implementations shown in FIG. 1 to FIG. 5. Details are omitted herein for simplicity.

The present specification further provides a computer program product. The computer program product stores at least one instruction. The at least one instruction is loaded by the processor and executes the method in the implementations shown in FIG. 1 to FIG. 5. For a specific execution process, reference can be made to specific descriptions of the implementations shown in FIG. 1 to FIG. 5. Details are omitted herein for simplicity.

An implementation of the present specification further provides a schematic structural diagram of an electronic device shown in FIG. 8. As shown in FIG. 8, at a hardware level, the electronic device includes a processor, an internal bus, a network interface, a memory, and a non-volatile memory, and certainly may further include hardware required by other services. The processor reads a corresponding computer program from the non-volatile memory to the memory and then runs the computer program to implement the above method.

Certainly, in addition to a software implementation, the present specification does not exclude other implementations, such as a logic device or a combination of software and hardware. In other words, an execution entity of the following processing flow is not limited to each logic unit, but can also be hardware or logic devices.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, at present, instead of manually manufacturing an integrated circuit chip, this type of programming is mostly implemented by using “logic compiler” software. The software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus included in the controller for implementing various functions can also be considered as a structure in the hardware component. Alternatively or additionally, the apparatus configured to implement various functions can even be considered as both a software module implementing the method and a structure in the hardware component.

Systems, apparatuses, modules, or units that are described in the above implementations can be for example implemented by using a computer chip or an entity, or by using a product with a certain function. A typical implementation device is a computer. For example, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the above apparatus is described by dividing functions into various units. Certainly, when the present specification is implemented, a function of each unit can be implemented in one or more pieces of software and/or hardware.

A person skilled in the art should understand that implementations of the present specification can be provided as methods, systems, or computer program products. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the methods, the devices (systems), and the computer program products based on implementations of the present specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

Alternatively or additionally, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

Alternatively or additionally, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in the present specification, the computer-readable medium does not include transitory computer-readable media (transitory media) such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

A person skilled in the art should understand that implementations of the present specification can be provided as a method, a system, or a computer program product. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification can be described in the general context of computer-executable instructions executed by a computer, for example, a program module. Generally, the program module includes a routine, a program, an object, a component, a data structure, etc. executing a specific task or implementing a specific abstract data type. The present specification can alternatively or additionally be practiced in distributed computing environments in which tasks are performed by remote processing devices that are connected through a communication network. In the distributed computing environments, the program module can be located in local and remote computer storage media including storage devices.

Implementations of the present specification are described in a progressive manner. For same or similar parts of the implementations, mutual references can be made to the implementations. Each implementation focuses on a difference from the other implementations. Particularly, the system implementations are basically similar to the method implementations, and therefore are described briefly. For related parts, references can be made to some descriptions of the method implementations.

The above-mentioned descriptions are merely some implementations of the present specification, and are not intended to limit the present specification. A person skilled in the art can make various variations and changes to the present specification. Any modification, equivalent replacement, and improvement made in the spirit and principle of the present specification shall fall within the scope of the claims in the present specification.

What is claimed is:

1. A joint training method for watermark embedding and detection, comprising:
obtaining training samples, the training samples each including a sample image watermark and a sample original image;
performing encoding processing on the sample image watermark based on the image encoder to obtain an embedded-watermark representation corresponding to the sample image watermark;
inputting the embedded-watermark representation and the sample original image into a watermark encoder for the watermark encoder to fuse the embedded-watermark representation into the sample original image to obtain a watermark-embedded image embedded with the sample image watermark;
inputting the watermark-embedded image into a watermark decoder to obtain a detected watermark corresponding to the watermark-embedded image; and
adjusting a parameter of one or more of the image encoder, the watermark encoder, or the watermark decoder to reduce one or more of a difference between the detected watermark and the sample image watermark or a difference between the watermark-embedded image and the sample original image.

2. The method according to claim 1, wherein the training samples each further include a watermark-free representation corresponding to the sample image watermark, and the method further comprises: before the inputting the watermark-embedded image into the watermark decoder to obtain the detected watermark corresponding to the watermark-embedded image,
inputting the sample original image into the watermark decoder to obtain an original detected representation corresponding to the sample original image;
the adjusting the parameter of one or more of the image encoder, the watermark encoder, or the watermark decoder includes:
adjusting the parameter of one or more of the image encoder, the watermark encoder, or the watermark decoder to reduce a difference between the original detected representation and the watermark-free representation.

3. The method according to claim 1, wherein the fusing the embedded-watermark representation into the sample original image to obtain the watermark-embedded image embedded with the sample image watermark includes:
performing noise addition processing on the sample original image to obtain a noise image; and
performing diffusion denoising processing on the noise image based on the embedded-watermark representation to obtain the watermark-embedded image embedded with the sample image watermark.

4. The method according to claim 3, wherein the performing the diffusion denoising processing on the noise image based on the embedded-watermark representation includes:
performing denoising noise prediction based on a number of denoising times, the embedded-watermark representation, and the noise image to obtain denoising noise;
performing denoising processing on the noise image based on the denoising noise to obtain an intermediate noise image;
in response to the number of denoising times not being zero, subtracting one from the number of denoising times to obtain an updated number of denoising times, using the intermediate noise image as an updated noise image, and performing the denoising noise prediction based on the updated number of denoising times, the embedded-watermark representation, and the updated noise image to obtain updated denoising noise, and performing denoising processing on the updated noise image based on the updated denoising noise to obtain an intermediate noise image; and
in response to the number of denoising times being reduced to zero, using an intermediate noise image obtained from a latest denoising processing as the watermark-embedded image.

5. The method according to claim 1, further comprising: before the inputting the watermark-embedded image into the watermark decoder to obtain the detected watermark corresponding to the watermark-embedded image,
performing image enhancement processing on the watermark-embedded image to obtain an enhanced watermark image,
wherein the inputting the watermark-embedded image into the watermark decoder to obtain the detected watermark corresponding to the watermark-embedded image includes:
inputting the enhanced watermark image into the watermark decoder to obtain a detected watermark corresponding to the enhanced watermark image.

6. The method according to claim 5, wherein the image enhancement processing includes at least one of image cropping processing, image brightness adjustment processing, image contrast adjustment processing, image grayscale processing, or image binarization processing.

7. The method according to claim 1, comprising:
obtaining an original image and an image watermark corresponding to the original image;
performing encoding processing on the image watermark using the image encoder to obtain an image watermark representation corresponding to the image watermark; and
performing encoding-based fusion on the original image and the image watermark representation using the watermark encoder to obtain a watermark-embedded image.

8. The method according to claim 1, comprising:
inputting a watermark embedded image into the watermark decoder, and
performing decoding processing using the watermark decoder to obtain a detected watermark corresponding to the watermark-embedded image.

9. A computing system comprising one or more processors and one or more storage devices, the one or more storage devices, individually or collectively, having computer executable instructions stored thereon, which when executed by the one or more processors, enable the one or more processors to, individually or collectively, perform actions including:
obtaining training samples, the training samples each including a sample image watermark and a sample original image;
performing encoding processing on the sample image watermark based on the image encoder to obtain an embedded-watermark representation corresponding to the sample image watermark;
inputting the embedded-watermark representation and the sample original image into a watermark encoder for the watermark encoder to fuse the embedded-watermark representation into the sample original image to obtain a watermark-embedded image embedded with the sample image watermark;
inputting the watermark-embedded image into a watermark decoder to obtain a detected watermark corresponding to the watermark-embedded image; and
adjusting a parameter of one or more of the image encoder, the watermark encoder, or the watermark decoder to reduce one or more of a difference between the detected watermark and the sample image watermark or a difference between the watermark-embedded image and the sample original image.

10. The computing system according to claim 9, wherein the training samples each further include a watermark-free representation corresponding to the sample image watermark, and the method further comprises: before the inputting the watermark-embedded image into the watermark decoder to obtain the detected watermark corresponding to the watermark-embedded image,
inputting the sample original image into the watermark decoder to obtain an original detected representation corresponding to the sample original image;
the adjusting the parameter of one or more of the image encoder, the watermark encoder, or the watermark decoder includes:
adjusting the parameter of one or more of the image encoder, the watermark encoder, or the watermark decoder to reduce a difference between the original detected representation and the watermark-free representation.

11. The computing system according to claim 9, wherein the fusing the embedded-watermark representation into the sample original image to obtain the watermark-embedded image embedded with the sample image watermark includes:
performing noise addition processing on the sample original image to obtain a noise image; and
performing diffusion denoising processing on the noise image based on the embedded-watermark representation to obtain the watermark-embedded image embedded with the sample image watermark.

12. The computing system according to claim 11, wherein the performing the diffusion denoising processing on the noise image based on the embedded-watermark representation includes:
performing denoising noise prediction based on a number of denoising times, the embedded-watermark representation, and the noise image to obtain denoising noise;
performing denoising processing on the noise image based on the denoising noise to obtain an intermediate noise image;
in response to the number of denoising times not being zero, subtracting one from the number of denoising times to obtain an updated number of denoising times, using the intermediate noise image as an updated noise image, and performing the denoising noise prediction based on the updated number of denoising times, the embedded-watermark representation, and the updated noise image to obtain updated denoising noise, and performing denoising processing on the updated noise image based on the updated denoising noise to obtain an intermediate noise image; and
in response to the number of denoising times being reduced to zero, using an intermediate noise image obtained from a latest denoising processing as the watermark-embedded image.

13. The computing system according to claim 9, further comprising: before the inputting the watermark-embedded image into the watermark decoder to obtain the detected watermark corresponding to the watermark-embedded image,
performing image enhancement processing on the watermark-embedded image to obtain an enhanced watermark image,
wherein the inputting the watermark-embedded image into the watermark decoder to obtain the detected watermark corresponding to the watermark-embedded image includes:
inputting the enhanced watermark image into the watermark decoder to obtain a detected watermark corresponding to the enhanced watermark image.

14. The computing system according to claim 13, wherein the image enhancement processing includes at least one of image cropping processing, image brightness adjustment processing, image contrast adjustment processing, image grayscale processing, or image binarization processing.

15. A non-transitory storage medium having computer executable instructions stored thereon, which when executed by one or more processors, enable the one or more processors to, individually or collectively, perform actions including:
obtaining training samples, the training samples each including a sample image watermark and a sample original image;
performing encoding processing on the sample image watermark based on the image encoder to obtain an embedded-watermark representation corresponding to the sample image watermark;
inputting the embedded-watermark representation and the sample original image into a watermark encoder for the watermark encoder to fuse the embedded-watermark representation into the sample original image to obtain a watermark-embedded image embedded with the sample image watermark;
inputting the watermark-embedded image into a watermark decoder to obtain a detected watermark corresponding to the watermark-embedded image; and
adjusting a parameter of one or more of the image encoder, the watermark encoder, or the watermark decoder to reduce one or more of a difference between the detected watermark and the sample image watermark or a difference between the watermark-embedded image and the sample original image.

16. The non-transitory storage medium according to claim 15, wherein the training samples each further include a watermark-free representation corresponding to the sample image watermark, and the method further comprises: before the inputting the watermark-embedded image into the watermark decoder to obtain the detected watermark corresponding to the watermark-embedded image,
inputting the sample original image into the watermark decoder to obtain an original detected representation corresponding to the sample original image;
the adjusting the parameter of one or more of the image encoder, the watermark encoder, or the watermark decoder includes:
adjusting the parameter of one or more of the image encoder, the watermark encoder, or the watermark decoder to reduce a difference between the original detected representation and the watermark-free representation.

17. The non-transitory storage medium according to claim 15, wherein the fusing the embedded-watermark representation into the sample original image to obtain the watermark-embedded image embedded with the sample image watermark includes:
performing noise addition processing on the sample original image to obtain a noise image; and
performing diffusion denoising processing on the noise image based on the embedded-watermark representation to obtain the watermark-embedded image embedded with the sample image watermark.

18. The non-transitory storage medium according to claim 17, wherein the performing the diffusion denoising processing on the noise image based on the embedded-watermark representation includes:
performing denoising noise prediction based on a number of denoising times, the embedded-watermark representation, and the noise image to obtain denoising noise;
performing denoising processing on the noise image based on the denoising noise to obtain an intermediate noise image;
in response to the number of denoising times not being zero, subtracting one from the number of denoising times to obtain an updated number of denoising times, using the intermediate noise image as an updated noise image, and performing the denoising noise prediction based on the updated number of denoising times, the embedded-watermark representation, and the updated noise image to obtain updated denoising noise, and performing denoising processing on the updated noise image based on the updated denoising noise to obtain an intermediate noise image; and
in response to the number of denoising times being reduced to zero, using an intermediate noise image obtained from a latest denoising processing as the watermark-embedded image.

19. The non-transitory storage medium according to claim 15, further comprising: before the inputting the watermark-embedded image into the watermark decoder to obtain the detected watermark corresponding to the watermark-embedded image,
performing image enhancement processing on the watermark-embedded image to obtain an enhanced watermark image,
wherein the inputting the watermark-embedded image into the watermark decoder to obtain the detected watermark corresponding to the watermark-embedded image includes:
inputting the enhanced watermark image into the watermark decoder to obtain a detected watermark corresponding to the enhanced watermark image.

20. The non-transitory storage medium according to claim 19, wherein the image enhancement processing includes at least one of image cropping processing, image brightness adjustment processing, image contrast adjustment processing, image grayscale processing, or image binarization processing.
